(19) United States
(12) Patent Application Publication
(10) Pub. No.: US 2024/0008389 A1
(43) Pub. Date: Jan. 11, 2024

(54) SYSTEMS, METHODS AND DEVICES FOR USING MACHINE LEARNING TO OPTIMIZE CROP RESIDUE MANAGEMENT

(71) Applicant: Groundtruth Ag, Inc., Arlington, VA (US)

(72) Inventors: John Richard Anderson, Jr., Raleigh, NC (US); Graham Hunter Bowers, Raleigh, NC (US); Clay Honeycutt, Roseboro, NC (US); Lars Dyrud, Great Falls, VA (US)

(73) Assignee: Groundtruth Ag, Inc., Arlington, VA (US)

(21) Appl. No.: 18/029,793

(22) PCT Filed: Sep. 28, 2021
(86) PCT No.: PCT/US2021/052399

§ 371 Date: Mar. 31, 2023

Related U.S. Application Data
(60) Provisional application No. 63/086,714, filed on Oct. 2, 2020.

(51) Int. Cl. A01B 79/00; G06V 20/10; G06V 10/143; G06V 20/56

(52) U.S. Cl. CPC A01B 79/005; G06V 20/188; G06V 10/143; G06V 20/56

(57) ABSTRACT

Systems, methods and devices for using machine learning to optimize crop residue management are provided. Operations of such methods include receiving, using a processing circuit and from multiple of sensors, crop residue data of a surface of a soil area, receiving, into the processing circuit and from a location sensor, geographic location data that corresponds to the crop residue data and generating multizone tillage data that is based on the crop residue data and that corresponds to a plurality of zones that are defined in the soil area.

### CROSS REFERENCE TO RELATED APPLICATIONS

The present PCT application claims domestic priority to U.S. Provisional Patent Application No. 63/086,714, filed on Oct. 2, 2020, the disclosure and content of which are incorporated by reference herein in their entirety.

### BACKGROUND

The present disclosure relates to agronomy, and, in particular, soil management and health using machine learning and sensor deployment concepts.

Farms are growing larger to meet global demand for commodities like corn, soybeans, wheat and cotton. As crop producers strive to achieve scale, they must do more work in the same number of calendar days and, as a result of climate change, even fewer workdays may be available to farmers.

Crop producers mitigate heavier workloads, i.e. farming more acreage, by increasing size and speed of their machinery. Many, especially those farming at northern latitudes, spread their workloads by shifting soil management activities, e.g. fertilization and tillage, from spring to fall. Accordingly, in recent years, land preparation between crop harvest and arrival of winter weather has intensified to the point that fall tillage may be crucial to overall farm productivity.

Intensification of tillage, particularly in the fall season, can lead to soil erosion and diminished surface water quality. To combat soil erosion on highly-erodible land (HEL), crop producers may, over winter, be compelled to leave 30% of the soil surface covered by residues from a previously-harvested crop. A thirty percent residue coverage may also be recommended for working lands that are not classified as highly-erodible.

While 30% coverage of the soil surface with crop residues may be a regulatory requirement for HEL that is farmed, measurement of the 30% residue coverage threshold is subjective.

There are: (a) no precise methods for quantifying and managing residue cover in prior art and there is (b) no precise method for ensuring that tillage implements are adjusted to leave 30% residue coverage or, for that matter, any particular level of residue coverage. The subjectivity of crop residue coverage is emphasized by a quote on the USDA Natural Resource Conservation Service website: “The person on the tractor seat is one of the keys to leaving heavy residues on the soil surface. Driving a little slower, tilling shallower, and correctly adjusting tillage equipment are ways you can make a difference.”

In summary, currently, there is no scalable, data driven approach for making crop residue management decisions in the time frame needed by crop producers. Post-harvest crop residues can vary significantly within fields and farming units and producers must manage those residues to achieve multiple, and often conflicting, agronomic, financial and environmental objectives. The present invention is a remedy that enables producers to identify and execute an optimal, site specific, residue management solution in near real time.

The approaches described in the Background section could be pursued, but are not necessarily approaches that have been previously conceived or pursued. Therefore, unless otherwise indicated herein, the approaches described in the Background section are not prior art to the claims in this application and are not admitted to be prior art by inclusion in the Background section.

### SUMMARY

Some embodiments herein are directed to methods that perform operations including receiving, using a processing circuit and from multiple sensors, crop residue data of a surface of a soil area. Operations include receiving, into the processing circuit and from a location sensor, geographic location data that corresponds to the crop residue data and generating multizone tillage data that is based on the crop residue data and that corresponds to multiple zones that are defined in the soil area.

Some embodiments herein are directed to systems that include a vehicle that is configured to travel over a surface of a soil area and a location device that is configured to provide geographic location data corresponding to the vehicle. Systems include at least two sensors that are caused to move above a surface of the soil area as the vehicle travels thereon and to generate crop residue data corresponding to the soil area. A processing circuit is communicatively coupled to the at least two sensors and to the location device, is configured to receive the geographic location data and the crop residue data, and to generate location associated crop residue data corresponding to the soil area.

Some embodiments herein are directed to a processing device that is on a vehicle and that includes a processing circuit and a memory that is coupled to the processing circuit. The memory includes instructions that, when executed by the processing circuit, causes the processing circuit to receive, using a processing circuit and from multiple sensors, crop residue data of a surface of a soil area and receive, into the processing circuit and from a location sensor, geographic location data that corresponds to the crop residue data. The processing circuit further generates multizone tillage data that is based on the crop residue data and that corresponds to multiple zones that are defined in the soil area.

Some embodiments herein are directed to a device that includes a first type of stand-off sensor that is configured to generate a first type of image data corresponding to crop residue of a surface of a soil area and a second type of stand-off sensor that is configured to generate a second type of image data corresponding to the crop residue of the surface of the soil area, the second type of image data being different from the first type of image data. A location sensor is configured to generate geographic location data corresponding to the device. A processing circuit is configured to receive the first type of image data, the second type of image data and the geographical location data.

Other methods, computer program products, devices and systems according to embodiments of the present disclosure will be or become apparent to one with skill in the art upon review of the following drawings and detailed description. It is intended that all such additional methods, computer program products, and systems be included within this description, be within the scope of the present disclosure, and be protected by the accompanying claims. Moreover, it is intended that all embodiments disclosed herein can be implemented separately or combined in any way and/or combination.

### BRIEF DRAWING DESCRIPTION

FIG. 1 is a schematic rendering of a system for using machine learning to optimize crop residue management according to some embodiments.

FIG. 2 is a block diagram illustrating a schematic view of a system according to some embodiments.

FIG. 3 is a schematic block diagram illustrating a managing crop residue according to some embodiments.

FIG. 4 is a schematic block diagram illustrating a system as described in FIG. 3 according to some embodiments.

FIG. 5 is a flowchart of operations according to some embodiments herein.

FIG. 6 is a schematic block diagram illustrating an electronic configuration for a computer according to some embodiments.

FIG. 7 is a flowchart of operations for training and using a machine learning model for operations according to some embodiments disclosed herein.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

Some embodiments of the present invention include scalable methods that employ non-invasive, standoff technologies to detect, visualize, quantify and manage intra- and inter-field agricultural crop residue in near real time.

In some embodiments, the telemetry device may transmit the transformed and fused data directly to a multiaccess “edge” cloud computing environment where the data may be deposited into a data lake structure. Some embodiments provide that, in the cloud computing environment, additional algorithms, analytics and machine learning protocols may access and utilize data from the data lake structure to create a visual image of subsurface crop residue.

Use of the onboard laptop to perform the calculative workload and immediate movement of that mathematical work product into the aforementioned multi-access cloud computing environment via the onboard telemetry device gives the present embodiments extremely low latency. Additional calculations may be performed and data transformation may occur in the cloud computing environment. In this manner, a farmer or interested party can, via an internet interface and mobile telephone, tablet and/or computer, view crop residue within a field, among fields in a farming unit, across a landscape or throughout an entire crop production enterprise. Given the computational design and telemetry integrated into the present embodiments, agricultural crop residue may be characterized and managed in real to near real time.

Soil and Water Conservation Districts, land grant universities and the USDA's Natural Resource Conservation Service recommend that crop producers ensure soil conservation compliance via visual methods, i.e. comparing their soil surface to online pictures of 30% residue cover, or using a line transect method. Both methods are error prone, time consuming and not practicable across large crop production enterprises. Furthermore, it is unrealistic to believe that a crop producer can make competent residue management decisions from the tractor seat. On today's farms, the person driving the tractor is seldom the person making residue management decisions.

All crop residues are not equal. Concomitant to increases in farm size and the transition from spring to fall fertilization and tillage, the crop improvement industry has, via genomics and plant breeding, supplied producers with corn, soybean and wheat products that have stronger stalks and stems. Stronger stalks and stems support higher planting densities and, with favorable growing conditions, higher planting densities, i.e. more seeds planted per acre, translate into higher yields.

However, farmers have discovered that high-yielding hybrids and varieties grown at higher densities have a notable downside. Today's harvested corn stalks are capable of puncturing tractor tires. In contrast to residues derived from older hybrids and varieties, modern row crop plants have more stronger, more lignified stalks and stems. It follows that modern crop residues are difficult to macerate with tillage implements, especially when those implements are operated at high speed by time-constrained farmers. Also, today's crop residues deteriorate slowly over winter, leading ironically, to the realization that producers with high-yielding crops frequently find themselves dealing with problematic, post-harvest quantities of hard-to-manage residue. Further obfuscating residue management is the fact that rates of residue decomposition vary with yield, cultivar, harvest height, soil type, climatic conditions and position on the landscape.

Thus, in the middle of the hectic fall work season, crop producers find themselves simultaneously: (a) challenged by soil compaction caused by heavy harvest equipment, e.g. tractors, trucks, grain carts and combines, (b) confronted with post-harvest crop residues that must be managed with tillage tools to create a proper seedbed for spring planting, (c) charged with leaving enough prior crop residue on the soil surface to prevent water and wind erosion, (d) concerned about sustaining organic matter levels and sequestering carbon for soil health reasons and (d) confused about where to deploy extremely expensive deep tillage.

A farmer may face demands of the fall workload on modern farms, the narrow window of time available to collect and act upon new information in the fall season, many variables affecting crop residue quantities and documented conservation and environmental benefits, including carbon sequestration, that accrue when residue is managed properly. Accordingly, embodiments herein may provide opportunities for producers and their agronomic advisors to characterize crop residues immediately, i.e. in near real time, after harvest, on a field by field basis and, in automated fashion, guide tillage implements to the best crop residue management solution for a given field and soil management objective, e.g. seedbed preparation, erosion control, water conservation in arid areas, etc. Embodiments herein may address the complexity of decision making when it comes to crop residue management by providing artificial intelligence solutions that are unconventional.

In recent years, multispectral satellite imagery has been used experimentally to estimate crop residue coverage and tillage intensity on farm fields. With respect to crop residues, satellite imagery is potentially useful for collecting landscape-scale data that can guide soil conservation policy. However, the resolution, reliability and accuracy of commercial satellite imagery may be inadequate for developing residue management recommendations at the field level. Moreover, satellite imagery processors struggle to discern between living and non-living vegetation in weedy farm fields and clouds interfere regularly with imagery interpretation. Paramount is the fact that satellite imagery providers cannot coordinate delivery of their images with fast-moving harvest operations. Simply put, fickle weather and accelerated farm logistics dictate that effective residue management decisions need to be made in minutes and hours “right behind the combine,” not the days and weeks required to collect and process viable satellite imagery.

In summary, currently, there is no scalable, data driven approach for making crop residue management decisions in the time frame needed by crop producers. Post-harvest crop residues can vary significantly within fields and farming units and producers must manage those residues to achieve multiple, and often conflicting, agronomic, financial and environmental objectives. Embodiments herein may provide a remedy that enables producers to identify and execute an optimal, site specific, residue management solution in near real time.

In some embodiments, methods, systems and apparatus disclosed herein may characterize, visualize and manage plant residues that remain in a field after a crop is harvested. Unlike any conventional residue management approaches, embodiments herein are data driven, may operate in (near) real time, may involve machine to machine communication and may use artificial intelligence and machine learning to support agronomic decision-making in the field.

Some embodiments provide that systems and methods herein include a multimodal payload of standoff sensors that are designed specifically to collect, in situ, post-harvest data corresponding to crop residues and the soil surface. In some embodiments, sensors in the payload include, but are not limited to, a multi-spectral camera and a laser technology, e.g. a scanning LiDAR unit. In this manner, multimodal sensor fusion, i.e. merging of data from two sensors and/or sensor types, to, in combination with machine learning, accurately estimate the quantity and disposition of crop residues while distinguishing them from living vegetation and soil. In some embodiments, the multimodal sensor payload may be deployed at a height in a non-limiting range from about one to about twenty feet above the soil surface on a harvesting machine and/or in a vehicle traveling behind a harvest machine. Non-limiting examples of such vehicles may include all-terrain vehicle (ATV), among others. For example, the trailing vehicle hosting the payload may be an ATV, a grain cart, an autonomous and/or battery-powered vehicle, a robot, an unmanned aircraft, a tractor pulling a tillage implement and/or another piece of farm machinery. In some embodiments, the payload may, in addition to a multispectral camera and LiDAR unit, include a ground-penetrating radar, an electromagnetic induction sensor and/or a laser-induced breakdown spectrometer (LIBS).

The vehicle hosting the sensor payload may also support a global positioning system (GPS) that enables precise, geospatial location of data collected by the payload, an onboard computer that, via a processing circuit, interacts with the GPS, the sensor payload and a cloud computing environment to translate, process and store geospatial data. To minimize data transmission latency, some embodiments of the invention may involve “edge” computing in which some calculations and data transformation, including machine learning protocols, are performed in the onboard computer instead of a cloud.

In some embodiments, the processing circuit may include artificial intelligence in which a computer that is informed by sensors in the payload, may be trained to recognize and classify different residue scenarios found in crop fields. Some embodiments provide that classification may be achieved by an onboard and/or cloud-based machine learning protocol that interfaces with pertinent metadata. Examples of such metadata include elevation, soil texture and drainage, among others. Embodiments may identify and store in memory any residue scenario encountered, along with its geospatial boundaries and/or coordinate(s). The machine learning protocol can distinguish between living vegetation and non-living crop residues and between crop residues and soil. In this manner, the percentage of the soil surface that is covered by non-living crop residues and living vegetation may be quantified with accuracy and precision.

In practice, sensors in the mobile payload may capture data describing crop residues and the processing circuit, in tandem with its machine learning component, may fuse and transform the sensor data into a geospatial map in which crop residues may be characterized and visualized with respect to height, volume and/or physical composition. For a given field, the artificial intelligence system may consider characteristics of the crop residues present, topography of the field, grower objectives and other pertinent parameters, among others. Some embodiments provide that in near real time, the geospatial map of crop residues may be divided into logical, residue management zones that collectively are a crop residue management map. Each management zone on that map may correspond to a unique set of adjustments for a tillage implement that will macerate and incorporate those residues into the soil, leaving the required amount of residue cover on the soil surface.

In some embodiments, the geospatial crop residue management map can function as a stand-alone source of actionable information for producers that can use the information to manually adjust their tillage implements to meet their residue management objectives.

In some embodiments, the residue management map provides information necessary to adjust tillage implements for different residue scenarios encountered at specific coordinates in specific fields. Some embodiments may generate a set of digital instructions, i.e. a “digital prescription” for management of the residue scenarios found in a given field and provide such instructions via a data transmission device, such as, a cellular telephone and/or software-defined radio. In some embodiments, the digital instructions may be communicated to a computer onboard a second trailing vehicle, usually a tractor towing a tillage implement and/or the tillage implement per se. In some embodiments, the computer may use the digital prescription to automatically adjust the tillage implement on-the-fly to achieve the desired soil management objective, e.g. 30% residue coverage or an optimal seedbed for spring planting or >30% residue coverage to maximize snow retention on field that historically suffers water deficits during the summer growing season.

It should not be overlooked that embodiments herein including the same machine learning protocol that quantifies the percentage of the soil surface covered by crop residue can be utilized, after a tillage operation, to quantitatively evaluate performance of a tillage implement, the effects of different tillage implement adjustments and, to a substantial degree, the ability of a tillage implement to create an ideal seedbed.

Some aspects disclosed herein include real-time or near real-time, data-driven methods for directing intra-field, inter-field and/or enterprise-wide management of crop residues with tillage implements. Embodiments may include machine learning-enabled direction of tillage implements, machine learning-enabled measurement of the percentage of a soil's surface covered by prior crop residues, machine-learning-enabled evaluation of tillage implement performance, and a highly-mobile payload of integrated, standoff sensors that collect data and, following multimodal sensor data fusion, characterize the height, volume and composition of crop residues and other vegetation remaining in a field following harvest of a crop.

Some embodiments provide that the sensor payload is deployed from a harvesting machine, an all-terrain vehicle, grain cart, tractor, tillage implement, robot or unmanned aircraft operating at low altitude.

In some embodiments, integrated sensors including the multimodal payload include a multi-spectral sensor (e.g. a multispectral camera functioning as a multi-spectral sensor), and one or more single point and/or scanning laser technologies (e.g. a scanning LiDAR unit), among others.

In some embodiments the multispectral sensor is a cellular telephone functioning as a multispectral sensor.

In some embodiments the multimodal payload includes one or more electromagnetic sensors, e.g. a ground-penetrating radar (GPR) and/or electromagnetic induction device (EMI) may be included in the payload with the multi-spectral sensor and laser unit.

In some embodiments, the multimodal payload includes a soil organic matter sensor that enables quantification of above-ground (residue) and below-ground (soil) carbon sources.

In some embodiments, the multimodal payload may be hosted by a manned and/or autonomous ATV that, in a single trip through a crop field, uses non-invasive, standoff sensors. In some embodiments, the non-invasive, standoff sensors may image crop residues and soil, collect data on soil nutrient composition, collect data on soil organic matter and biological activity, collect data on soil compaction and soil physical health, and/or collect data on the functionality of tile drainage systems.

Some embodiments include a global positioning system, a data transmission device, a cloud computing environment and an artificial intelligence/machine learning processing system connected to a highly mobile payload of integrated sensors via a processing circuit hosted by a mobile computer.

Some embodiments provide an automated, artificial intelligence processing system that informs and directs management of crop residues. Some embodiments provide an automated, artificial intelligence processing system that receives, analyzes, and interprets data in real time. Some embodiments provide an automated, artificial intelligence processing system informed by a multimodal payload of highly mobile sensors. Some embodiments provide an automated, artificial intelligence processing system and unique graphical user interface (GUI) that assesses residue management tradeoffs; via the GUI, the artificial intelligence processing system communicates actionable information that enables a crop producer or land manager to optimize management of crop residues to fulfill his/her agronomic, economic, environmental and/or soil health objectives.

Some embodiments provide an automated, artificial intelligence processing system that considers crop residue management objectives, such as the need to control soil erosion, and/or the need to increase soil organic matter, etc. by relying on site-specific metadata and crop residue scenarios that are classified by a machine learning platform.

Some embodiments provide machine learning protocols operating within an artificial intelligence processing system. In such embodiments, validated images and actual measurements of crop residues may be collected from diverse field environments as training datasets. A computer may be trained to transform standoff sensor data to identify crop residues and accurately estimate crop residue characteristics.

In some embodiments, machine learning protocols use multimodal sensor data, including digital photography, to distinguish between living and non-living vegetation, distinguish between soil and living and non-living vegetation, estimate the percentage of the soil surface covered by non-living crop residues and living vegetation following harvest of a crop or use of a tillage implement, estimate rates of crop residue decomposition and/or classify crop residue management scenarios.

In some embodiments, an artificial intelligence processing system may classify crop residue scenarios (height, volume, composition, decomposition rate, location, etc.) and geospatially locate crop residues into zones for management purposes.

In some embodiments, a site-specific map of crop residues and other vegetation remaining in an individual field following harvest of a crop may be generated.

Some embodiments provide a site-specific map of crop residues and other vegetation generated from data collected by sensors positioned near the ground. Such embodiments may be in contrast with wide area residue cover and tillage intensity maps generated from satellite imagery or high-altitude aerial platforms for purposes of developing agricultural policy.

Some embodiments provide a site-specific map of crop residues and other vegetation that is of sufficient detail and resolution so as to be useful to a crop producer making intra-field residue management decisions that impact soil health.

Some embodiments provide a site-specific map of crop residues and other vegetation in which variability of crop residues and remaining vegetation is charted and grouped into zones for management purposes.

Some embodiments are directed to a processing circuit that transforms output from the automated, artificial intelligence processing system plus metadata, such as elevation, historical climatic data, etc., and the site-specific map of crop residues and non-crop vegetation, into a set of digital commands that may include a digital prescription, that, ex ante, may instruct a tillage implement to manage crop residues and remaining vegetation in a specific way that optimizes soil for planting of the next crop while improving soil health and satisfying the regulatory requirement for over-winter erosion control.

Operations corresponding to methods herein may include transmitting data from a harvesting machine, an ATV trailing a harvesting machine and/or a robot and/or unmanned aircraft trailing a harvesting machine, to the cab computer of a different trailing vehicle that has a tillage implement in tow.

Some embodiments include real time and/or near real time data transmission from a harvesting machine, an ATV trailing a harvesting machine and/or a robot and/or unmanned aircraft trailing a harvesting machine, to the cab computer of a different trailing vehicle that has a tillage implement in tow.

Some embodiments provide that tillage implements may be manually controlled based on information contained in a site-specific map of crop residues.

Some embodiments provide that tillage implements are automatically controlled the set of digital instructions received from a harvesting machine and/or other machines hosting a payload as disclosed herein.

In some embodiments, a sensor payload and/or artificial intelligence processing circuit may evaluate ex post performance of a tillage implement with respect to crop residue. In some embodiments, sensor payload and/or artificial intelligence processing circuit may evaluate performance of conservation tillage implements.

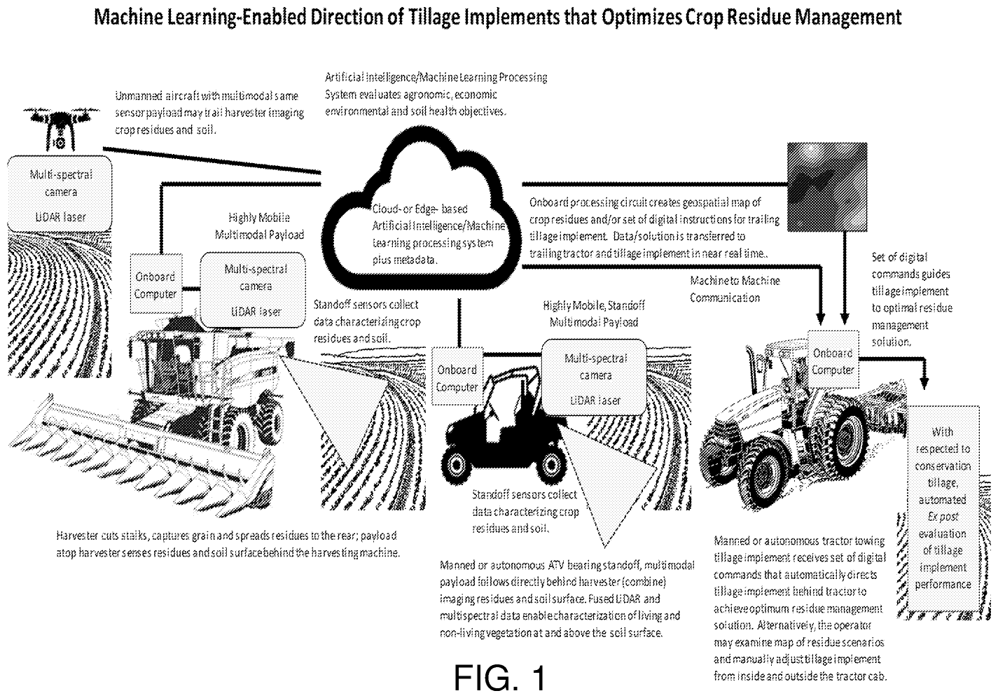

Reference is now made to FIG. 1, which is a schematic rendering of a system for using machine learning to optimize crop residue management according to some embodiments. As illustrated an unmanned aircraft may include a multimode sensor payload that may capture image data corresponding to crop residues. In some embodiments, the unmanned aircraft may be configured to traverse a soil area autonomously based on a predefined map. In some embodiments, the unmanned aircraft may be configured to trail a harvesting vehicle to capture the image data corresponding to the crop residue and/or soil.

Some embodiments provide that unmanned aircraft may be tethered to the harvesting equipment. In such embodiments, the unmanned aircraft may receive control and power signal via the tether. Some embodiments provide that the unmanned aircraft is not physically coupled to the harvesting equipment.

In some embodiments, the multimode sensor payload may include a multi-spectral camera and/or a scanning LiDAR laser, among others. The unmanned aircraft and/or the harvesting equipment may include one or more processing circuits that may receive crop residue image data from the sensors and/or geographical location data from a location sensor that that may be on the unmanned aircraft and/or the harvesting equipment.

In some embodiments, a computing device may be supported by the vehicle and may receive and/or store sensor data that is received from the sensors. Some embodiments provide that the computer comprises a hardened weather-resistant laptop computer, but such embodiments are non-limiting as the computer may include a different form factor including mobile telephone, tablet, and/or fixedly mounted computer.

In some embodiments, the processing circuit on the unmanned aircraft may cause the crop residue and soil image data to be sent to a remotely located processing circuit. The remotely located processing circuit may include artificial intelligence and/or machine learning cloud-based computers that are configured to receive the data from the sensors, location device, farmer input, economic, agronomic, and/or soil health objective data, among others. Based on the received data, the artificial intelligence and/or machine learning computers may generate crop residue data and/or digital instructions for a trailing tillage implement. In some embodiments, the crop residue data may include a geospatial map that may include data corresponding to the digital instructions.

In some embodiments, the remotely located processing circuit may include an edge-based computing system. Some embodiments provide that edge computing offers an efficient alternative in that data may be processed closer to the point of creation and/or acquisition. Because the data does not traverse over a network to a cloud or data center to be processed, latency may be significantly reduced.

The crop residue data generated by the remotely located processing circuit may be sent to a vehicle that includes a tillage implement. In some embodiments, the vehicle includes a computer that is configured to receive the digital instructions for the tillage implement and to cause the tillage implement to perform tillage operations according to the instructions.

A location and/or navigation device may be provided in the vehicle and may generate geographic location information corresponding to the vehicle. For example, some embodiments provide that the location and/or navigation device comprises a differential geographic positioning system (GPS). Location data from the location and/or navigation device may be provided to the computer. In some embodiments, the computer may associate the location data with the sensor data that is received from the sensors. In this manner, the crop residue data corresponding to each location that is traversed by the vehicle may be determined to provide location specific crop residue data.

Although discussed above as an unmanned aircraft, embodiments herein provide that multimode sensor payload may be mounted on harvesting equipment to provide crop residue information as the harvest operations are being performed.

Further, some embodiments provide that the multimode sensor payload may be mounted on a manned and/or autonomous terrestrial vehicle, such as an all-terrain vehicle (ATV). In some embodiments, the ATV with the multimode sensor payload may follow behind harvesting equipment and capture images of crop residues and/or soil conditions as the harvest is being performed. Some embodiments provide that the combination of the LiDAR and multispectral data may enable characterization of living and non-living vegetation at and/or above the surface of the soil.

In some embodiments, a tillage vehicle may include a manned and/or unmanned tractor that may tow a tillage implement, which receives digital commands that automatically direct the tillage implement that is behind the tractor to achieve an optimum crop residue management solution. Some embodiments provide that the operator may examine the map of crop residue scenarios and manually adjust the tillage implement from inside the cab of the tractor.

A telemetry device may transmit the location specific soil compaction data from the computer to a remote computer and/or data repository using any combination of wired and/or wireless communication protocols and/or technologies. In some embodiments, the remote computer may perform additional analysis and may generated a three-dimensional crop residue map corresponding to the location specific crop residue data among others.

In some embodiments, the digital instructions may include a tillage prescription plan that includes data identifying which areas of the soil should be tilled. The tillage prescription plan may further include data regarding how deep different areas should be tilled to overcome the crop residue. In some embodiments, the tillage prescription plan may be transmitted to one or more agriculture vehicles that include automated tilling implements that are towed and/or mounted thereto. For example, digital instructions may be transmitted to a tractor cab to control the tilling implement to till the soil surface according to the tillage prescription plan.

By selectively tilling different portions of the soil surface, advantages may include time savings, fuel savings, equipment cost savings, green-house gas emission reductions, and ecological system damage reduction.

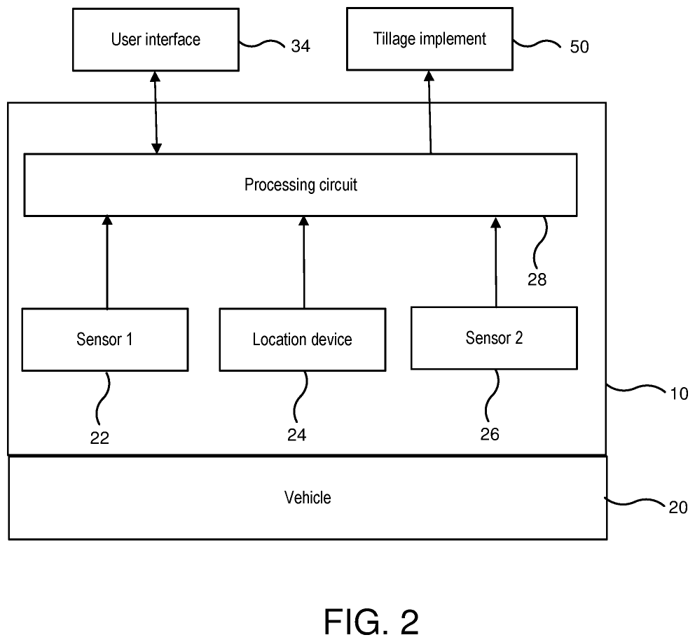

Reference is now made to FIG. 2, which is a block diagram illustrating a schematic view of a system according to some embodiments herein. According to some embodiments, a system includes a vehicle 20 that is configured to travel over a surface of a soil area, a location device 24 that is configured to provide geographic location data corresponding to the vehicle 20, at least two sensors 22, 26 that are caused to move above a surface of the soil area as the vehicle travels thereon and to generate crop residue data corresponding to the soil area and a processing circuit 28 that is communicatively coupled to the at least two sensors 22, 26 and to the location device 24, that is configured to receive the geographic location data and the crop residue data, and to generate location associated crop residue data corresponding to the soil area.

In some embodiments, the soil area includes multiple zones that each correspond to a specific geographic location.

In some embodiments, the location associated crop residue data includes elevation data corresponding to the crop residue data. Some embodiments provide that the vehicle 20 is a self-driving vehicle and is configured to traverse the soil area in a path that is defined by a coverage plan that is based on the geographic location data.

In some embodiments, the vehicle 20 is an airborne vehicle and is configured to fly over the soil area based on self-generated lift. Some embodiments provide that the airborne vehicle is configured to fly over the soil area in a pattern that is defined by a coverage plan that is based on the geographic location data.

In some embodiments, the crop residue data includes living vegetation data and non-living vegetation data.

Some embodiments provide the sensors 22, 26 are stand-off sensors that are configured to be operated at a given distance from the surface of the soil area. In some embodiments, the stand-off sensors include multiple types of stand-off sensors. For example, in some embodiments, the types of stand-off sensors include an image capture device and a light detection and ranging (LiDAR) device. In some embodiments, the LiDAR device includes a scanning LiDAR. Some embodiments provide that the image capture device is a multi-spectral camera. In some embodiments, the stand-off sensors are configured to operate at a height above the surface of the soil area that is in a range of about 1 foot to about 20 feet. Such range is no-limiting as the range may include values that are less that 1 foot and/or greater than 20 feet.

Some embodiments provide that the sensors 22, 26 are part of and/or attached to a multi-mode payload structure 10 that may include and/or be attached to a vehicle 20. In some embodiments, the multimode payload structure 10 may be and/or be attached to an unmanned aircraft that is configured to fly above the surface of the soil area for the at least two sensors 22, 26 to generate crop residue data of the surface of the soil area.

In some embodiments, the unmanned aircraft is configured to fly over the soil area in a pattern that is defined by a coverage plan that is based on the geographic location data.

In some embodiments, the multi-mode payload structure is configured to be attached to a harvesting vehicle that is operable to perform harvest operations on the soil area, wherein the at least two sensors on the multi-mode payload structure are configured to generate the crop residue data of the surface of the soil area while the harvesting vehicle is performing harvest operations. In some embodiments, crop residue data corresponds to conditions resulting from the harvest operations.

Some embodiments provide that the multi-mode payload structure 10 is and/or includes a ground vehicle that is configured to traverse the soil area to generate crop residue data. In some embodiments, the ground vehicle is a self-driving ground vehicle and is configured to traverse the soil area in a path that is defined by a coverage plan that is based on the geographic location data.

In some embodiments, the system includes an interface that is operable to receive farmer goal data that corresponds to a crop residue goal of a farmer of the soil area. Some embodiments provide that the location associated crop residue data is further based on the crop residue goal of the farmer. In some embodiments, the farmer goal data corresponds to a compliance crop residue goal corresponding to a regulatory requirement.

Some embodiments provide that the geographic location data includes global positioning system (GPS) data.

In some embodiments, the processing circuit 28 is configured to generate the multizone tillage data that is based on the crop residue data using artificial intelligence and/or machine learning.

In some embodiments, the processing circuit 28 includes a decentralized processing circuit that includes cloud-based processing and/or data storage.

Some embodiments provide that the processing circuit 28 includes a processer that is on board an aircraft and/or a terrestrial vehicle. In some embodiments, the processing circuit 28 includes a processor that is on board a harvesting vehicle.

Some embodiments provide that the processing circuit 28 generates tillage implement data corresponding to each of the zones. In some embodiments, the tillage implement data is used to automatically control a tillage implement 50 to modify a crop residue characteristic. Some embodiments provide that tillage implement data is configured to be received by a user to manually control the tillage implement 50 to modify a crop residue characteristic. In some embodiments, the tillage implement data includes digital commands that include information for controlling the tillage implement 50 to modify a crop residue characteristic.

In some embodiments, the location associated crop residue data that corresponds to the zones includes a geospatial map of the crop residue in the soil area. In some embodiments, the geospatial map includes a visualization of the crop residue in the zones of the soil area. Some embodiments provide that the processing circuit 28 is further configured to generate the digital commands and to transmit the digital commands a tilling vehicle that includes the tillage implement 50. Some embodiments provide that the tilling vehicle and/or the tillage implement 50 are configured to implement the digital commands.

In some embodiments, the processing circuit 28 includes a first computer that is located on the vehicle and a second computer that is remote from the vehicle. The first computer is configured to generate location associated crop residue data and to transmit the location associated crop residue data to a data repository that is accessible by the second computer. The second computer is configured to receive the location associated crop residue data and to generate digital commands for controlling the tillage implement.

Some embodiments provide that the second computer is further configured to transmit the location associated crop residue data to a tilling vehicle.

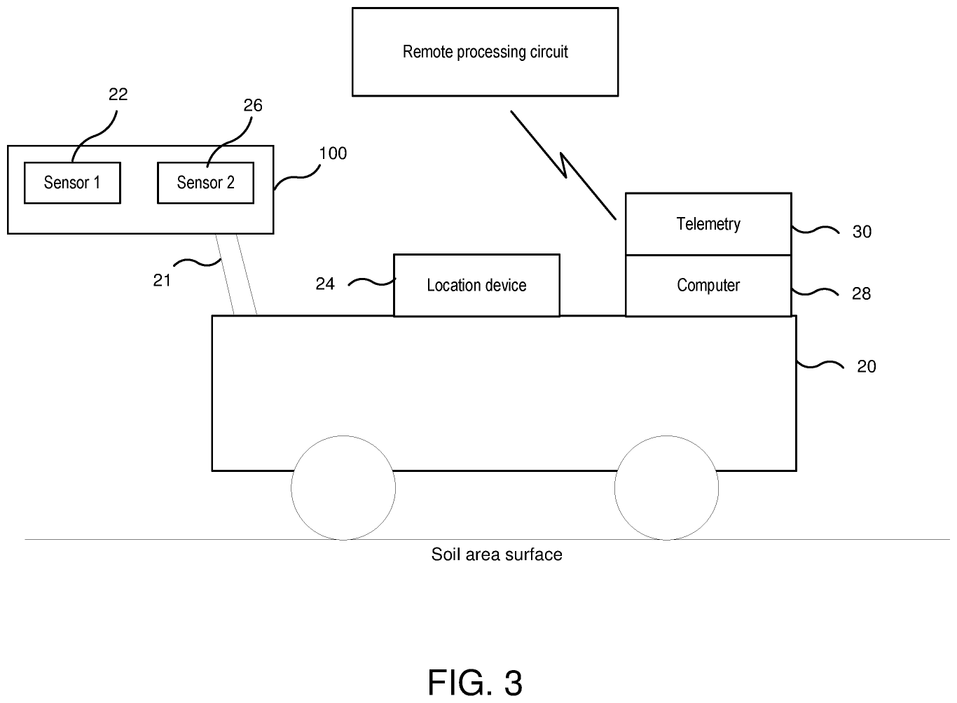

Reference is now made to FIG. 3, which is a schematic block diagram illustrating a managing crop residue according to some embodiments. A system according to some embodiments includes a vehicle 20 that is configured to travel over a soil area. A location device 24 is configured to provide geographic location data corresponding to the vehicle 20. A multimode payload 100 may be attached to the vehicle 20 and may include at least two sensors 22, 26 such that movement of the vehicle 20 across the soil area causes the at least two sensors 22, 26 to move above a surface of the soil area as the vehicle 20 travels thereon and to generate data relating to crop residue and/or the soil corresponding to the soil area. Depending on the sensor technology, the at least one sensor 22 (Sensor 1) may include a multispectral camera and at least one sensor may include a scanning LiDAR (Sensor 2). A computer 28 is communicatively coupled to the at least one sensor 22, 26 and to the location device 24. The computer 28 may be configured to receive the geographic location data and the data relating to the crop residue and/or soil surface. The computer 28 may be further configured to generate location associated data relating to the crop residue and/or soil surface.

In some embodiments, the sensors 22, 26 are stand-off sensors that are configured to operate a distance away from the surface of the soil area. Some embodiments provide that sensors 22, 26 are configured to move in a range from 1 foot above the surface of the soil area to about 20 feet above the surface of the soil area. However, such range is non-limiting as the sensor 22, 26 may be configured to operate at an elevation that is higher than 20 feet relative to the soil surface.

Some embodiments include a multimode payload support 21 that is configured to physically support the multimode payload including at least the two sensors 22, 26.

In some embodiments, the vehicle 20 is a self-driving vehicle and is configured to traverse the soil area in a path that is defined by a coverage plan that is based on the geographic location data. For example, a terrestrially operating vehicle such as a self-driving ATV, cart, or tractor may use the location data in conjunction with a coverage plan to traverse the soil are in the predefined path.

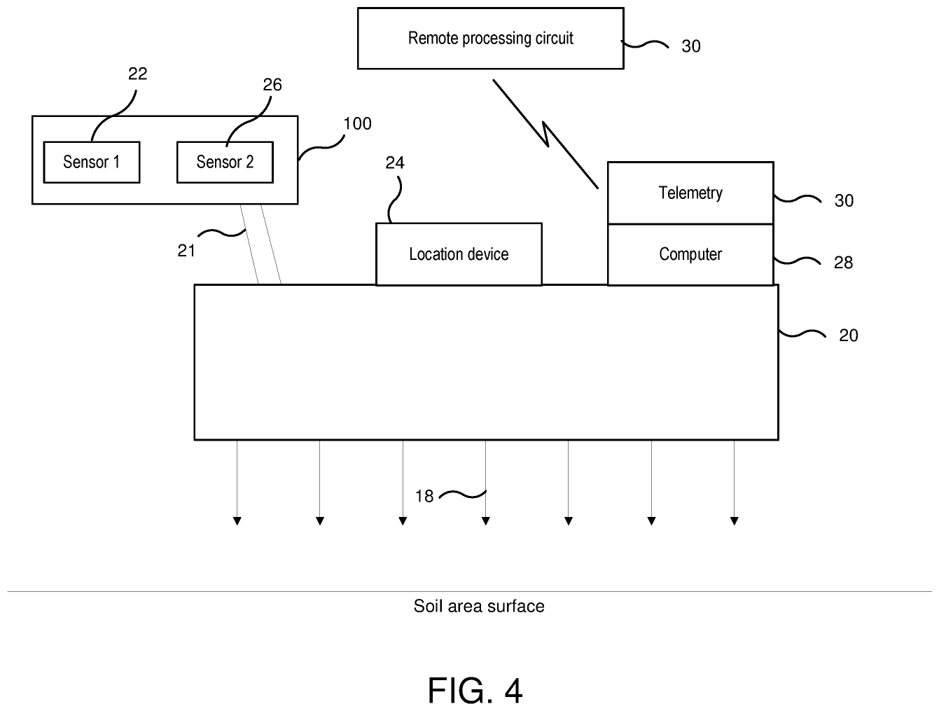

Brief reference is now made to FIG. 4, which is a schematic block diagram illustrating a system as described in FIG. 3 including an airborne vehicle according to some embodiments. In some embodiments, the vehicle comprises an airborne vehicle and is configured to fly over the soil area based on self-generated lift 18. In some embodiments, the airborne vehicle is an autonomously flying drone that operates according to a predefined coverage plan that may define elevation, speed and path. Some embodiments provide that the drone is tethered to a ground station and/or another vehicle while other embodiments provide that the drone is untethered. In some embodiments, the drone may include telemetry 30 for transmitting the generated data during and/or after flight. Some embodiments provide that the drone include on board memory for storing the generated data.

In some embodiments, the airborne vehicle is configured to fly over the soil area in a pattern that is defined by a coverage plan that is based on the geographic location data.

Referring back to FIG. 3, some embodiments provide that the computer 28 is further configured to generate a tillage prescription plan for the soil area that is based on the location associated soil compaction data. In some embodiments, the tillage prescription plan includes data that identifies a first portion of soil area not to till and a second portion of the soil area to till. Some embodiments provide that the tillage prescription plan includes data that identifies multiple different portions of the soil surface that each correspond to a different tilling depth.

Some embodiments provide that the computer 28 is coupled to telemetry 30 for transmitting tillage prescription data to a tilling vehicle that includes a tilling implement. Although not illustrated, embodiments herein contemplate that various intervening devices and/or equipment may be in a communication path between the computer 28 and a tilling implement. The tilling vehicle and/or the tilling implement are configured to implement the tillage prescription plan by varying tillage depth based on a tilling location.

In some embodiments, the tilling implement is propelled by the tilling vehicle. Some embodiments provide that the tilling implement varies the tilling depth based on using an electrical, mechanical and/or hydraulic positioning component to vary the depth of the tilling implement and thus the tilling depth. Some embodiments provide that the tilling implement is mounted to the tilling vehicle and is positioned to vary the tilling depth. In some embodiments, the tillage prescription plan is implemented automatically by the tilling vehicle and/or the tilling implement.

Some embodiments provide that sensors 22, 26 are located either in the front of the vehicle 20 or the rear of the vehicle and are configured to generate the data corresponding to the soil area. In such embodiments, the vehicle 20 may include a tilling implement that is at a rear portion of the vehicle 20 and that is configured to vary the tilling depth of the soil area behind the vehicle 20. In some embodiments, the tillage prescription data is transmitted to tilling vehicle in substantially real-time relative to generation of the location associated soil compaction data.

Some embodiments provide that the computer 28 is located at the vehicle and that a second computer is remote from the vehicle 20. The computer 28 may be further configured to generate the location associated crop residue data and to transmit the location crop residue data to a data repository that is accessible by the second computer. In some embodiments, the second computer is configured to receive the location associated crop residue data and to generate a tillage prescription plan for the soil area that is based on the location associated crop residue data. In some embodiments, the second computer is further configured to transmit the tillage prescription plan to a tilling vehicle.

In some embodiments, the first and/or second sensors may include stand-off sensors. As provided herein, a stand-off sensor may include a sensor that may use electromagnetic, optical, seismic and/or acoustical methods to measure the properties of soil without actually physically contacting the soil surface. In some embodiments, measurements received using a stand-off sensor may be referred to as remote sensing.

Some embodiments provide that a stand-off sensor may traverse the top surface of the soil without substantially penetrating and/or otherwise disturbing the soil. In this manner, sensors according to some embodiments may be non-invasive and may be referred to as “standoff” sensors.

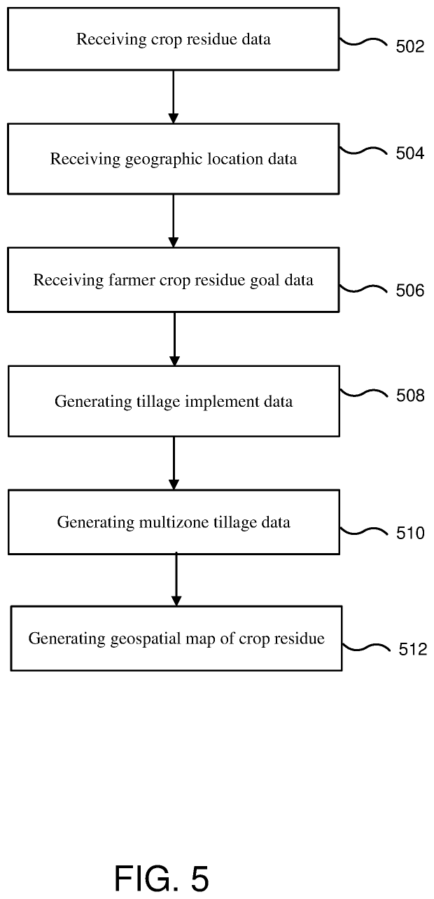

Reference is now made to FIG. 5, which is a flowchart of operations according to some embodiments herein. According to some methods herein, operations may include receiving (block 502) crop residue data of a surface of a soil area using a processing circuit and from multiple sensors. In some embodiments, the crop residue data includes living vegetation data and non-living vegetation data. The multiple sensors may include stand-off sensors that are configured to be operated at a given distance from the surface of the soil area.

Some embodiments provide that the stand-off sensors include multiple types of stand-off sensors. In some embodiments, the types of stand-off sensors include an image capture device and a light detection and ranging (LiDAR) device. Some embodiments provide that the LiDAR device includes a scanning LiDAR. In some embodiments, the image capture device includes a multi-spectral camera. Some embodiments provide that the stand-off sensors are configured to operate at a height above the surface of the soil area that is in a range of about 1 foot to about 20 feet.

Operations may include receiving (block 504) geographic location data that corresponds to the crop residue data, into the processing circuit and from a location sensor. In some embodiments, the geographic location data includes global positioning system (GPS) data.

Operations include receiving (block 506) farmer goal data that corresponds to a crop residue goal of a farmer of the soil area. In some embodiments, the farmer goal data corresponds to a compliance crop residue goal corresponding to regulatory a requirement.

Operations may include generating (block 508) tillage implement data for the multiple zones. In some embodiments, the tillage implement data is used to automatically control a tillage implement to modify a crop residue characteristic. Some embodiments provide that the tillage implement data is configured to be received by a user to manually control tillage implement to modify a crop residue characteristic. In some embodiments, the tillage implement data includes digital commands that include information for controlling the tillage implement to modify a crop residue characteristic.

Some embodiments include generating (block 510) multizone tillage data that is based on the crop residue data and that corresponds to a plurality of zones that are defined in the soil area. In some embodiments, generating the multizone tillage data that is based on the crop residue data and that corresponds to the zones includes generating (block 512) a geospatial map of the crop residue in the soil area. In some embodiments, generating the geospatial map includes generating a visualization of the crop residue in the of zones of the soil area. Some embodiments provide that generating multizone tillage data is further based on the crop residue goal of the farmer.

In some embodiments, the sensors are attached to a multi-mode payload structure. Some embodiments provide the multi-mode payload structure includes an unmanned aircraft that is configured to fly above the surface of the soil area for sensors to generate crop residue data of the surface of the soil area. In some embodiments, the unmanned aircraft is configured to fly over the soil area in a pattern that is defined by a coverage plan that is based on the geographic location data.

In some embodiments, the multi-mode payload structure is configured to be attached to a harvesting vehicle that is configured to performed harvest operations on the soil area, wherein the sensors on the multi-mode payload structure are configured to generate the crop residue data of the surface of the soil area while the harvesting vehicle is performing harvest operations. In some embodiments, crop residue data corresponds to conditions resulting from the harvest operations.

Some embodiments provide that the multi-mode payload structure includes a ground vehicle that is configured to traverse the soil area to generate crop residue data. In some embodiments, the ground vehicle includes a self-driving ground vehicle and is configured to traverse the soil area in a path that is defined by a coverage plan that is based on the geographic location data.

Some embodiments provide that the processing circuit is configured to generate the multizone tillage data that is based on the crop residue data using artificial intelligence and/or machine learning.

In some embodiments, the processing circuit includes a decentralized processing circuit that includes cloud-based processing and/or data storage.

Some embodiments provide that the processing circuit includes a processer that is on board an aircraft and/or a terrestrial vehicle.

In some embodiments, the processing circuit includes a processor that is on board a harvesting vehicle.

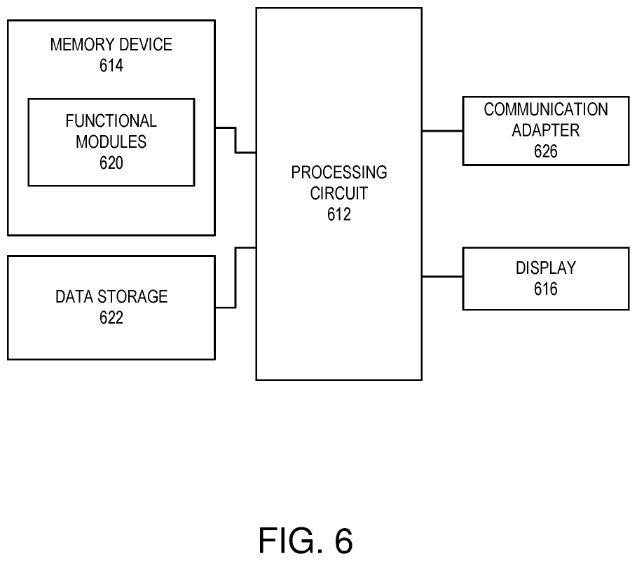

FIG. 6 is a schematic block diagram illustrating an electronic configuration for a computer according to some embodiments. As shown in FIG. 6, the computer 28 may include a processing circuit 612 that controls operations of the computer 28. Although illustrated as a single processing circuit, multiple special purpose and/or general-purpose processors and/or processor cores may be provided in the computer 28. For example, the computer 28 may include one or more of a video processor, a signal processor, a sound processor and/or a communication controller that performs one or more control functions within the computer 28. The processing circuit 612 may be variously referred to as a “controller,” “microcontroller,” “microprocessor” or simply a “computer.” The processing circuit may further include one or more application-specific integrated circuits (ASICs).

Various components of the computer 28 are illustrated as being connected to the processing circuit 612. It will be appreciated that the components may be connected to the processing circuit 612 through a system bus, a communication bus and controller, such as a USB controller and USB bus, a network interface, or any other suitable type of connection.

The computer 28 further includes a memory device 614 that stores one or more functional modules 620.

The memory device 614 may store program code and instructions, executable by the processing circuit 612, to control the computer 28. The memory device 614 may also store other data such as image data, event data, user input data, and/or algorithms, among others. The memory device 614 may include random access memory (RAM), which can include non-volatile RAM (NVRAM), magnetic RAM (ARAM), ferroelectric RAM (FeRAM) and other forms as commonly understood in the gaming industry. In some embodiments, the memory device 614 may include read only memory (ROM). In some embodiments, the memory device 614 may include flash memory and/or EEPROM (electrically erasable programmable read only memory). Any other suitable magnetic, optical and/or semiconductor memory may operate in conjunction with the gaming device disclosed herein.

The computer 28 may further include a data storage device 622, such as a hard disk drive or flash memory. The data storage device 622 may store program data, player data, audit trail data or any other type of data. The data storage device 622 may include a detachable or removable memory device, including, but not limited to, a suitable cartridge, disk, CD ROM, DVD or USB memory device.

In some embodiments, the data set regarding a physical aspect of the soil is analyzed with a neural network. A neural network according to some embodiments includes a training set that includes a data set regarding the soil area. The data set may include weather, physical, chemical, structural, topographical, and/or geographical data. In some embodiments, a visualization of the data set may depict the crop residue of the soil area and may be displayed in at least two dimensions. For example, some embodiments provide that the visualization may be displayed in three or more dimensions. Some embodiments provide that a prescription for tilling the soil area for crop residue goals based on the visualization of the data set. In some embodiments, the at least two dimensions include depth and density of the soil area and the visualization includes at least one other dimension.

Although discussed herein as including neural networks for processing and/or analyzing data, some embodiments herein may rely on one or more algorithms including statistical and/or machine learning techniques. Such labelling techniques may include, but are not limited to, labeling of data with semi-supervised classification, labeling of data with unsupervised classification, DBSCAN, and/or K-means clustering, among others. Such classification techniques may include, but are not limited to linear models, ordinary least squares regression (OLSR), stepwise regression, multivariate adaptive regression splines (MARS), locally estimated scatterplot smoothing (LOESS), ridge regression, least absolute shrinkage and selection operator (LASSO), elastic net, least-angle regression (LARS), logistic regression, decision tree, other tree-based algorithms (e.g. ADA-Boost), support vector machine, and neural network based learning. Neural network-based learning may include feed forward neural networks, convolutional neural nets, recurrent neural nets, long/short term memory neural, auto encoders, generative adversarial networks [especially for synthetic data creation], radial basis function network, and any of these can be referred to as “deep” neural networks. Additionally, ensembling techniques to combine multiple models, bootstrap aggregating (bagging), random forest, gradient boosted models, and/or stacknet may be used.

Additionally, in some embodiments, training data may optionally be transformed using dimension reducing techniques, such as principal components analysis, among others.

Laser-induced breakdown spectroscopy. To accelerate collection and measurement of soil nutrient levels, some embodiments use LIBS, a standoff, laser-based technology that has, to date, been used, for the most part, to detect metallic elements in civil engineering and industrial applications. Some embodiments include portable LIBS units. Laser-induced breakdown spectroscopy has been adapted for use in aqueous environments and, in the laboratory, it has been used to measure elements in soil. Some embodiments provide that LIBS can measure elements that are essential to a crop plant as well as elements customarily found on a soil test report. In addition, LIBS has been used to estimate soil carbon, a viable surrogate for OM values found on soil test reports. In some embodiments, LIBS may be used to measure soil nutrients, in situ, in a farm field. Some embodiments provide that automated LIBS are used, in either multimodal or autonomous fashion, for agricultural purposes.

Some embodiments provide a mobile, self-propelled, soil health and management laboratory (MSHML). It can be operated autonomously or manually. A multimodal trifecta of sensors may be deployed in combination. The MSHML payload comprises simultaneous use of ground-penetrating radar (GPR), laser-induced breakdown spectroscopy (LIBS) and electromagnetic induction (EMI) sensors, deployed, in this case, to collect and fuse information about physical, chemical and biological characteristics of soil. Embodiments provide a data upload capability and communications link that connects the MSHML to a cloud computing environment.

In some embodiments, placement of these particular sensors, GPR, EMI and LIBS, onto an autonomous, all-terrain vehicle (ATV), and integration of those sensors with other digital technologies, on and off the ATV constitute an automated, standoff method for assessing soil health and quality. Via the machine and methods presented herein, one can collect, transmit and display reliable information about physical, chemical and biological characteristics of soil in near real time, in effect, delivering essential information a farmer needs to manage for a healthy soil. Some embodiments provide a near real time assessment of soil health, delivered in a context suitable for crop producer use. In some embodiments, the MSHML is a self-propelled suite of devices, sensors and technologies used in combination for the purpose of monitoring soil health. The machine consists of an ATV that can be operated manually or autonomously. The ATV may transport an automated, multimodal payload consisting of GPR, LIBS and EMI sensors. Other components on the ATV are integrated with the stacked sensor payload. Components include a power source, an electrical converter, a computer hardened for outdoor use, a differential global positioning system (GPS), a conventional or multispectral camera and a wireless data communication system. Collectively, the “stacked” sensor payload and these elements provide near real time wireless transmission of data describing physical, chemical and biological characteristics of soil into a cloud computing enterprise.

Some embodiments use commercial technology to wirelessly transmit data directly into a computing environment architecture, such as a hybrid enterprise cloud, the enterprise being a data lake, i.e. a database configuration that: manages structured and unstructured data, supports visual analytics and facilitates machine learning focused upon below ground attributes of soil. Therein, computer code, algorithms and analytics fuse data from the respective sensors to generate unique visualizations and assessments relevant to soil health and management.

In some embodiments, in a directed sampling mode, responding to wireless commands from its laptop control station, the machine moves to the desired latitude and longitude in a farm field. In some embodiments, the MSHML uses a nearest neighbor, statistical algorithm that considers historical productivity, elevation and other parameters to select optimum sampling sites. Finally, the MSHML can be programmed to grid sample, i.e. to collect measurements at coordinates corresponding to a grid, e.g. the 2.5-acre to 5.0-acre grid that is commonly used for variable rate fertilizer application.

In some embodiments, a processing device, such as the computer 28 referenced in FIGS. 3-5, may be removable and/or fixably mounted to and/or supported by a vehicle 20. In some embodiments, the processing circuit 612 may be configured to receive, from a location device, geographic location data corresponding to a location of the vehicle. The processing circuit 612 may be further configured to receive, from a sensor that is proximate the vehicle, data relating to a crop residue of a soil area. The processing circuit 612 may further generate location associated data that relates the geographic location data to the crop residue of the soil area at respective locations corresponding to the geographic location data.

Some embodiments provide that the sensor is caused to move above a surface of the soil area as the vehicle travels thereon and to generate the crop residue data corresponding to the soil area. In some embodiments, the data relating to the crop residue of the soil includes electrical conductivity.

In some embodiments, the soil area includes multiple soil area elements that may each correspond to a specific geographic location and a corresponding location associated soil compaction data value. Some embodiments provide that each soil area element includes an area that is in a range from about one square foot to about ten acres.

In some embodiments, the processing circuit includes a first processing circuit that is located on the vehicle 20 and a second processing circuit that is remote from the vehicle 20. For example, the first processing circuit may be configured to generate the location associated soil compaction data and to transmit the location associated compaction data to a data repository that is accessible by the second processing circuit and/or directly to the second processing circuit. In some embodiments, the processing circuit is configured to receive the location associated soil compaction data and to generate a tillage prescription plan for the soil area that is based on the location associated soil compaction data. In some embodiments, the second processing circuit is further configured to transmit the tillage prescription plan to a tilling vehicle 20.

Some embodiments provide that the processing circuit is further configured to generate the location associated physical, chemical and/or biological characteristic data of the soil and to generate a tillage prescription plan for the soil area that is based on the location associated physical, chemical and/or biological characteristic data. In some embodiments, the vehicle 20 includes the tilling implement and the processing circuit is further configured to cause the tilling implement to perform the tillage prescription plan.

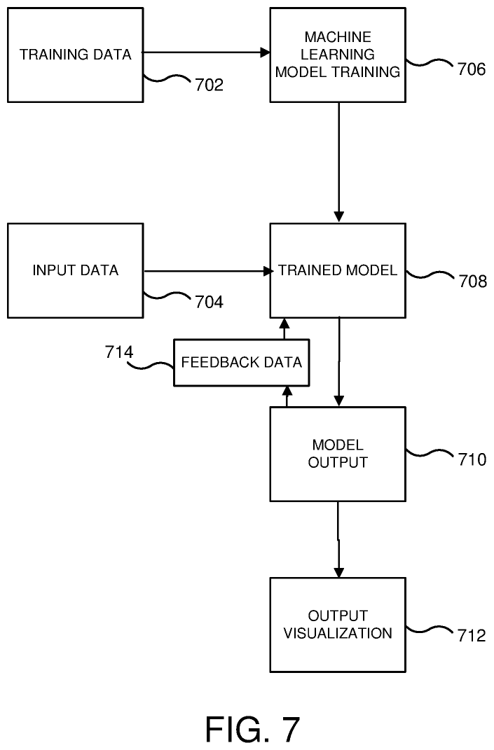

Reference is now made to FIG. 7, which is a flowchart of operations for training and using a machine learning model for operations according to some embodiments disclosed herein. Some embodiments provide that training data (block 702) is provided to a machine learning platform as disclosed herein. The machine learning platform may perform machine learning model training using the training data that is provided (block 706). The training data may include penetrometer curves, ground penetrating radar (GPR) scans and/or electromagnetic interference (EMI) scans, among others. The training data values may all be georeferenced according to some embodiments herein. In some embodiments, training data may include air and/or ground temperature, volumetric moisture content, digital elevation model images, soil and crop residue image results from multimode sensor payloads, among others. The machine learning model may be trained using any of the techniques described herein, including, for example, random forest, among others. The result of the training may include a trained machine learning model (block 708).

Once the machine learning model is trained, input data 704 may be provided to the model, which may generate model output data 710. The input data 704 may include soil and crop residue data and the trained model 708 may analyze image data from a multi spectrum camera and/or a scanning LiDAR, among others. In some embodiments, sensors that gather the data may be configured to be above a soil surface from about 1 foot to about feet in height. The model output data 710 may include predicted and/or estimated crop residue data that may be used to understand achieve crop residue goals.

The model output data 710 may be used to generate an output visualization (block 712). For example, the output data may be expressed as a geospatial map.

In some embodiments, the model output data 710 may be used as feedback 714 that may be provided to the trained model 708 to increase the performance of the trained model 708.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1.-114. (canceled)

115. A method comprising:
receiving, using a processing circuit and from an image capture device and a light detection and ranging (LiDAR) device configured to be operated at a given distance above the surface of the soil area, crop residue data comprises living vegetation data and non-living vegetation data of a surface of a soil area;
receiving, into the processing circuit and from a location sensor, geographic location data that corresponds to the crop residue data; and
generating multizone tillage data that is based on the crop residue data and that corresponds to a plurality of zones that are defined in the soil area.

116. The method of claim 115, wherein the LiDAR device comprises a scanning LiDAR and the image capture device comprises a multi-spectral camera.

117. The method of claim 115, wherein the plurality of image capture device and a light detection and ranging (LiDAR) device are attached to a ground vehicle structure attached to a harvesting vehicle that is configured to performed harvest operations on the soil area, wherein the image capture device and a light detection and ranging (LiDAR) device on the ground vehicle structure generate the crop residue data of the surface of the soil area while the harvesting vehicle is performing harvest operations.

118. The method of claim 115, further comprising receiving farmer goal data that corresponds to a crop residue goal of a farmer of the soil area,
wherein generating multizone tillage data is further based on the crop residue goal of the farmer.

119. The method of claim 115, wherein the processing circuit is configured to generate the multizone tillage data that is based on the crop residue data using artificial intelligence and/or machine learning.

120. The method of claim 115, further comprising generating tillage implement data corresponding to each of the plurality of zones, wherein the tillage implement data comprises digital commands that include information for controlling the tillage implement to modify a crop residue characteristic.

121. A system comprising:
a vehicle that is configured to travel over a surface of a soil area;
a location device that is configured to provide geographic location data corresponding to the vehicle;
at least two sensors comprising different stand-off sensors that are configured to be operated at a given distance above the surface of the soil area that are attached to the vehicle and caused to move above a surface of the soil area as the vehicle travels thereon and to generate crop residue data corresponding to the soil area, the crop residue data comprises a living vegetation data and non-living vegetation data; and
a processing circuit that is communicatively coupled to the at least two sensors and to the location device, that is configured to receive the geographic location data and the crop residue data, and to generate location associated crop residue data corresponding to the soil area.

122. The system of claim 121, wherein the vehicle is configured to traverse the soil area in a path that is defined by a coverage plan that is based on the geographic location data.

123. The system of claim 121, wherein the at least two sensors comprise a multi-spectral camera and a scanning light detection and ranging (LiDAR) device.

124. The system of claim 121, wherein the at least two sensors are configured to operate at a height above the surface of the soil area that is in a range of about 1 foot to about 20 feet.

125. The system of claim 121, further comprising an interface that is operable to receive farmer goal data that corresponds to a crop residue goal of a farmer of the soil area, wherein the location associated crop residue data is further based on the crop residue goal of the farmer.

126. The system of claim 121, wherein the processing circuit is configured to generate multizone tillage data that is based on the crop residue data using artificial intelligence and/or machine learning.

127. The system of claim 121, wherein the processing circuit comprises a decentralized processing circuit that includes cloud-based processing and/or data storage.

128. The system of claim 121, further comprising generating tillage implement data corresponding to each of the plurality of zones, wherein the tillage implement data is used to automatically control a tillage implement to modify a crop residue characteristic.

129. The system of claim 121, wherein the location associated crop residue data that corresponds to the plurality of zones comprises a geospatial map of the crop residue in the soil area comprising a visualization of the crop residue in the plurality of zones of the soil area.

130. A device comprising:
a first type of stand-off sensor that s configured to generate a first type of image data corresponding to crop residue of a surface of a soil area;
a second type of stand-off sensor that is configured to generate a second type of image data corresponding to the crop residue of the surface of the soil area, the second type of image data being different from the first type of image data;
a location sensor that is configured to generate geographic location data corresponding to the device; and
a processing circuit that is configured to receive the first type of image data, the second type of image data and the geographical location data to generate crop residue data comprising multizone tillage data based on the first type of image data, the second type of image data and the geographical location data.

131. The device of claim 130, wherein the first type of stand-off sensor comprises a multi-spectral camera.

132. The device of claim 130, wherein the second type of stand-off sensor comprises a scanning LiDAR.

133. The device of claim 130, wherein the processing circuit is further configured to generate tillage implement data corresponding to each of the plurality of zones, wherein the tillage implement data comprises digital commands that include information for controlling the tillage implement to modify a crop residue characteristic.

134. The device of claim 130, wherein generating the multizone tillage data that is based on the crop residue data and that corresponds to the plurality of zones comprises generating a geospatial map of the crop residue in the soil area.
